(19) United States
(12) Patent Application Publication
(10) Pub. No.: US 2003/0235923 A1
(43) Pub. Date: Dec. 25, 2003

(54) Acceptance testing method for sets of multiple colored workpieces

(76) Inventors: Franklin A. Jurik, Pleasanton, CA (US); Manoj Sharma, Milpitas, CA (US); Carol F. Chang, San Francisco, CA (US); Vinh Hoang, San Jose, CA (US)

Correspondence Address: Mayumi Maeda, LifeScan, Inc., 1000 Gibraltar Drive, Milpitas, CA, 95035, US

(21) Appl. No.: 10/177,820

(22) Filed: Jun. 21, 2002

(51) Int. Cl. G01N 21/77

(52) U.S. Cl. 436/169; 436/164; 422/55; 422/56; 435/14

(57) ABSTRACT

A method for the acceptance testing of a set of multiple colored workpieces (e.g., paired color pads of a calibrated color chart or paired membranes of visual blood glucose test strip). The method includes first measuring a plurality of color parameters (e.g., L*a*b* color parameters) associated with the set of multiple colored workpieces, followed by conversion of the plurality of color parameters into a single response parameter. Next, the single response parameter for the set is compared to a predetermined single response parameter specification for the set and acceptance of the set of multiple colored workpieces determined based on the comparison. The method can be easily employed in conjunction with multiple (e.g., paired) membrane test strips used to measure, for example, glucose, cholesterol, proteins, ketones, phenylalanine or enzymes in blood, urine, saliva or other biological fluid and/or sample fluid characteristics such as pH and alkalinity.

### BACKGROUND OF INVENTION

1. Field of the Invention

This invention relates, in general, to methods for the acceptance testing of colored workpieces and, in particular, to methods for the acceptance testing of sets of multiple colored workpieces, such as paired color pads of a calibrated color chart or paired membranes of a visual blood glucose test strip, based on color parameter data.

2. Description of the Related Art

In the manufacturing of colored objects (i.e., colored workpieces), it is often necessary to perform acceptance testing based on the color(s) of the colored workpiece. Such acceptance testing typically relies on any of a variety of standard color definition systems that specify color parameters for individual colors (e.g., one of the color systems defined by the Commission Internationale de l'Eclairage [CIE] including the systems based on the L*a*b* color space and L*C*h* color space) or visual evaluation.

Acceptance testing of colored workpieces is frequently performed by obtaining CIE L*, a* and b* colorimetric parameter data (hereinafter referred to as “L*a*b*” color parameters) on individual (i.e., single) colors of the colored workpiece and then comparing each of the three L*a*b* color parameters to an associated color parameter specification. Alternatively, the L*a*b* color parameters can be used to compute a ΔE*_{ab} value with respect to a color reference standard using methods known to one skilled in the art. Such a ΔE*_{ab} value is an absolute quantity indicative of the difference of a single color of the colored workpiece undergoing acceptance testing to the color reference standard. The ΔE*_{ab} value, however, merely represents the magnitude of color difference but does not identify the direction of bias from the color reference standard. Acceptance testing of colored workpieces can also be similarly performed by using other color systems. Using these conventional methods, an individual color of a colored workpiece can be compared to color parameter specifications or a color reference standard and the colored workpiece either rejected or accepted based on that comparison.

In some circumstances, multiple (i.e., two or more) colored workpieces of different colors are manufactured and/or employed as a “set” of multiple colored workpieces. A set of two colored workpieces can be termed a “paired set” of colored workpieces.

U.S. Pat. No. 6,162,397, which is fully incorporated herein by reference, describes a visual blood glucose test strip with two side-by-side membranes (i.e., dual membranes or paired membranes). Such paired membranes contain reagents which react with blood glucose to form visibly different colors (see also, Sherwood, M. et al., A New Reagent Strip (Visidex™) for Determination of Glucose in Whole Blood, Clinical Chemistry, 438-446[1983]). A user can subsequently compare the two colors thus formed to a calibrated color chart (e.g., a color chart that includes sets of paired color pads) to ascertain blood glucose concentration. Once reacted with blood glucose, the paired membranes of such a visual blood glucose test strip can be considered a paired set of colored workpieces. In addition, any paired color pads of a calibrated color chart can also be considered a paired set of colored workpieces.

FIG. 1 is a top plan view of a conventional visual blood glucose test strip 10.

FIG. 2 depicts an exemplary calibrated color chart 200 for use with visual blood glucose test strip 10. Visual blood glucose test strip 10 includes a spreading top layer 12, an intermediate layer 14 with two membranes 14a and 14b (i.e., paired membranes 14a and 14b), and a support layer 16 with openings 16a and 16b. In operation, a user applies a blood sample to spreading top layer 12. As the blood sample penetrates spreading top layer 12, the blood sample spreads out and is substantially and uniformly distributed to paired membranes 14a and 14b. Glucose in the blood sample reacts with reagents in the paired membranes 14a, 14b, as it passes toward support layer 16, to form visually different colors in each of the paired membranes. The colors are viewed through openings 16a and 16b and compared with the paired color pads 202a-202h of calibrated color chart 200 to determine the blood glucose concentration of the blood sample. For the purpose of explanation only, calibrated color chart 200 in FIG. 2 is depicted to include eight sets of paired color pads (202a through 202h), each corresponding to one of eight targeted blood glucose test levels (e.g., 25, 50, 80, 120, 180, 240, 400 and 600 mg/dL). A user obtains a result by visually matching the paired membranes of a reacted visual blood glucose test strip to a paired set of color pads on calibrated color chart 200.

During manufacturing of sets of multiple colored workpieces (e.g., the paired color pads of a calibrated color chart) or items that will be employed as a set of multiple colored workpieces (e.g., paired membranes of a visual blood glucose test strip), it can be desirable to perform acceptance testing of a set of multiple colored workpieces as a set, rather than on a one-by-one basis. By performing an acceptance test on a set basis, the potential interaction of the colors of the workpieces to the acceptability of the entire set can be assessed, in addition to the contribution of the colors on an individual basis. Since conventional methods of acceptance testing compare an individual color either to color parameter specifications or to a standard reference color, they are not particularly suited for the acceptance testing of a set of multiple colored workpieces. Furthermore, conventional methods of acceptance testing are typically instrument-based and do not account for user-related visual effects.

Still needed in the field, therefore, is a simple method for the acceptance testing of a set of multiple colored workpieces. In addition, the method should be instrument-based yet capable of accounting for user-related visual effects.

### SUMMARY OF INVENTION

The present invention provides a simple method for the acceptance testing of a set of multiple colored workpieces (e.g., a paired set of two workpieces). The method is instrument-based and, therefore, objective, yet capable of accounting for user-related visual effects.

A method for the acceptance testing of a set of multiple colored workpieces according to one exemplary embodiment of the present invention includes first measuring a plurality of color parameters associated with the set of multiple colored workpieces. Although the method is detailed below in terms of CIE L*a*b* color parameters, paired membranes of a visual blood glucose test strip and paired color pads of a calibrated color chart for ease of description, once apprised of the present disclosure one skilled in the art will recognize that color parameters of other color systems and/or other sets of multiple colored workpieces can be utilized in practicing the invention. For example, the set of multiple colored workpieces can include any number of multiple colored workpieces. In general, the set of multiple colored workpieces can include “m” colored workpieces where “m” is two or greater. It is also contemplated that methods in accordance with the present invention can be easily employed in conjunction with multiple (e.g., paired) membrane test strips used to measure, for example, glucose, cholesterol, proteins, ketones, phenylalanine or enzymes in blood, urine, saliva or other biological fluid and/or sample fluid characteristics such as pH and alkalinity.

Next, the plurality of color parameters associated with the set of multiple colored workpieces is converted into a single response parameter. The single response parameter can be, for example, related to an intended application of the set (e.g., blood glucose measurement). The single response parameter for the set is subsequently compared to a predetermined single response parameter specification for the set and acceptance of the set of multiple colored workpieces is then determined based on the comparison.

Methods in accordance with the present invention are simple since only a single response parameter for each set need be compared to a single response parameter specification, rather than comparing multiple color parameters to multiple color parameter specifications in conventional methods where an acceptance test of a set of multiple colored workpieces is performed one color at a time. In addition, the conversion of color parameters measured from the set of multiple colored workpieces into a single response parameter can account for interactions between the individual colors of the multiple colored workpieces and/or for any user-related visual effects. Furthermore, since the color parameters can be measured instrumentally in an objective manner, cumbersome and subjective visual acceptance testing is avoided.

### BRIEF DESCRIPTION OF DRAWINGS

A better understanding of the features and advantages of the present invention will be obtained by reference to the following detailed description that sets forth illustrative embodiments, in which the principles of the invention are utilized, and the accompanying drawings of which:

FIG. 1 is a bottom plan view of an exemplary conventional visual blood glucose test strip as may be used in connection with the present invention;

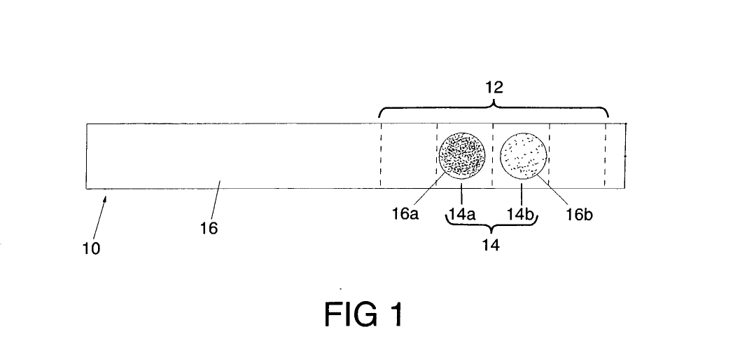

FIG. 2 is a top plan view of an exemplary calibrated color chart as may be used in the present invention;

FIG. 3 is a flow diagram illustrating a sequence of steps in a process in accordance with one exemplary embodiment of the present invention;

FIG. 4 is a flow diagram illustrating a sequence of steps in a process according to one exemplary embodiment of the present invention for the acceptance testing of calibrated color charts with paired color pads; and

FIG. 5 is a flow diagram illustrating a sequence of steps in a process according to another exemplary embodiment of the present invention for the acceptance testing of visual blood glucose test strips with paired membranes.

### DETAILED DESCRIPTION OF THE INVENTION

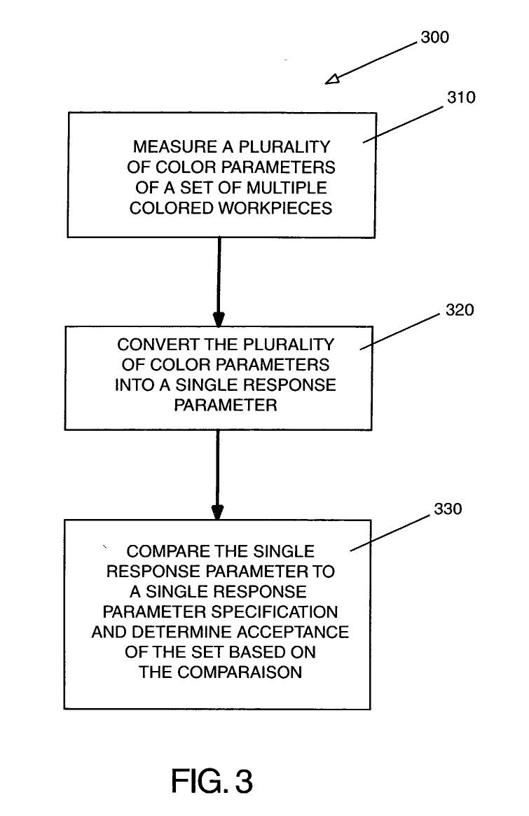

FIG. 3 is a flow chart illustrating a sequence of steps in a process 300 for the acceptance testing of a set of multiple colored workpieces according to an exemplary embodiment of the present invention. Process 300 includes measuring a plurality of color parameters associated with the set of multiple colored workpieces, as set forth in step 310. The measuring of the color parameters can be accomplished using instruments and methods well known to one skilled in the art. For example, commercially available color parameter instruments such as a Minolta Chromameter model CR-241 (available from Minolta Co. Ltd, Osaka, Japan) or commercially available spectrophotometers can be employed to measure the color parameters.

The color parameters associated with the paired set of colored workpieces include, but are not limited to, L*a*b* color parameters of the L*a*b* color space; X, Y and Z color parameters of the XYZ tristimulus space; Y, x and y color parameters of the Yxy color space; L*C*h* color parameters of the L*C*h* color space, and HL, a and b color parameters of the Hunter Lab color system. In the circumstance that L*a*b* color parameters are measured, the result of such a measurement will be three discrete color parameters for each of the multiple colored workpieces. For example, if the set of multiple colored workpieces contains two colored workpieces (i.e., a paired set) the result will be six discrete color parameters. Whereas, if the set of multiple colored workpieces contains three colored workpieces, the result will be nine discrete color parameters. In general, for “m” colored workpieces on which “n” color parameters are measured, the result will be m·n discrete color parameters.

The set of multiple colored workpieces can be any set of multiple colored workpieces known to one skilled in the art. In particular, methods according to the present invention can be beneficially employed with paired color pads of a calibrated color chart and reacted/unreacted paired membranes of a visual glucose test strip as the set of multiple colored workpieces. Moreover, one skilled in the art will recognize that an acceptance test according to the present invention may involve measuring numerous sets of multiple colored workpieces. For example, an acceptance test can involve measuring a series of paired membranes, each pair having been subjected to samples of different blood glucose concentration, or a series of paired color pads on a single calibrated color chart. One skilled in the art will also recognize that although an acceptance test method according to the present invention is conducted on a particular set(s) of multiple colored workpieces, the outcome of the method can determine acceptance for an entire production lot from which the particular set(s) of multiple colored workpieces was sampled.

Next, as set forth in step 320, the measured plurality of color parameters associated with the set are converted into a single response parameter for the set. If desired, the single response parameter can be related to the set's intended application. For example, if the set is dual membranes of a blood glucose test strip the single response parameter can be recited in terms of blood glucose concentration (e.g., mg/dL of blood glucose). In addition, the single response parameter can be devised such that it provides direction from a reference value (e.g., from a predetermined single response parameter specification.).

The conversion can be accomplished, for example, utilizing an algorithm that relates the single response parameter (P) to the n measured color parameters (CP₁ to CP_{n·m}). In general, such an algorithm takes the form of:

P=f(CP₁,CP_{2,} . . . CP_{n·m})

where: P is the single response parameter; and

CP₁, CP₂ . . . CPn m are the n m color parameters associated with the m colored workpieces of the set.

The algorithm employed to convert the plurality of color parameters into a single response parameter can be obtained, for example, by regressing a plurality of color parameters measured on a plurality of standard reference multiple colored workpieces against predetermined target single response parameters for each of the standard reference multiple colored workpieces in a linear combination. In this regard, it should be noted that some of color parameters may prove to be insignificant and, therefore, not be present in the algorithm whereas other more significant color parameters may dominate the algorithm.

Optionally, the algorithm can account for user-related visual effects that are not explicitly represented by the instrumentally measured color parameters. The user-related visual effects can, for example, appear in the algorithm as an interactive term containing color parameters from two or more colored workpieces, as an offset and/or as a multiplier.

Once apprised of the present invention, one skilled in the art may devise alternative techniques for obtaining an algorithm for converting the plurality of color parameters into a single response parameter. For example, non-linear modeling techniques, genetic algorithm techniques or neural network techniques known to those skilled in the art can be employed to obtain the algorithm.

Converting the plurality of color parameters into a single response parameter provides at least three benefits. First, the acceptance testing of the set of multiple colored workpieces is simplified since only a single response parameter need be compared to a single predetermined response parameter specification, rather than comparing a plurality of color parameters to a plurality of color parameter specifications.

Second, the conversion step can account for interactions between the plurality of color parameters, including between color parameters measured on each of the multiple colored workpieces. For example, individual colored workpieces that might be considered unacceptable when tested as individuals can conceivably interact as a set in a manner that renders the set acceptable or vice versa. Such an interaction can be accounted for in an algorithm employed in the conversion step.

Third, an algorithm employed in the converting step can account for user-related visual effects that are not directly measured in the measurement step by the use of, for example, experimentally or theoretically derived correction factor(s) or correlations. This aspect of the invention is particularly beneficial when the set of multiple colored workpieces is to be visually evaluated by a user.

Next, the single response parameter for the set is compared to a predetermined single response parameter specification for the set of multiple colored workpieces and acceptance of the set of multiple colored workpieces determined based on the comparison, as set forth in step 330 of FIG. 3.

Exemplary Method for Acceptance Testing of a Color Chart with Paired Color Pads

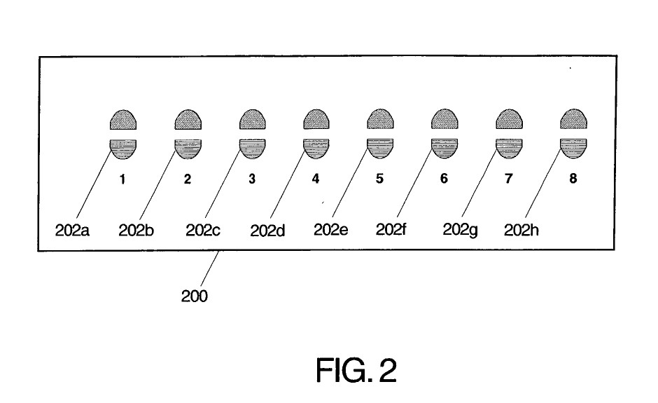

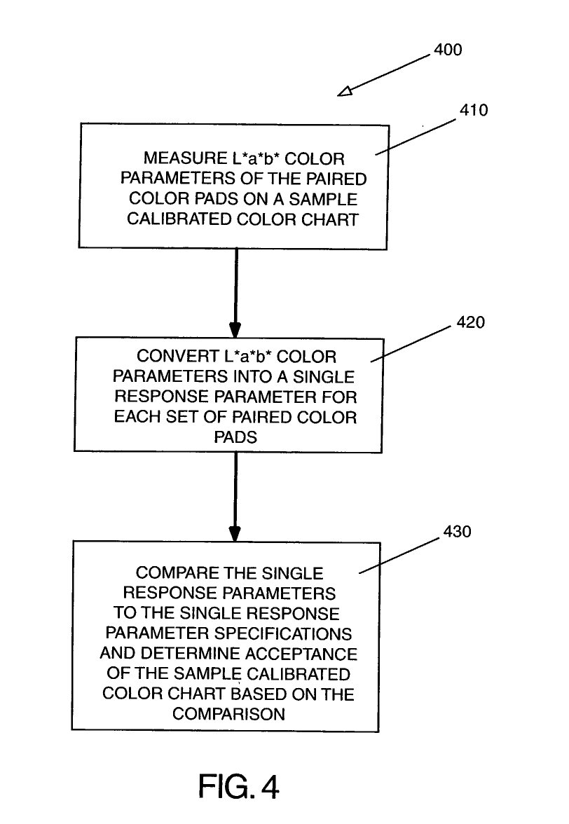

Referring to FIGS. 2 and 4, a method 400 that was developed for the acceptance testing of an exemplary calibrated color chart 200 with paired color pads is described. For the purpose of illustration only, calibrated color chart 200 in FIG. 2 is depicted to include eight sets of paired color pads (202a through 202h), each corresponding to one of eight targeted blood glucose test levels (e.g., 25, 50, 80, 120, 180, 240, 400 and 600 mg/dL). However, a calibrated color chart with any suitable numbered sets of paired color pads can be employed in conjunction with the method 400.

As set forth in step 410, three color parameters (i.e., L*a*b*) were measured for each of eight sets of paired color pads on a sample calibrated color chart undergoing acceptance testing using a Minolta Chromameter. Since there were eight sets of paired color pads 202a-202h on the calibrated color chart 200, this measurement step resulted in forty-eight L*a*b* color parameters. In each set of paired color pads 202a-202h of calibrated color chart 200, one of the pads was customarily referred to as the “blue” color pad and the other as the “yellow” color pad.

Next, as set forth in step 420, the measured L*a*b* color parameters for each set of paired color pads was converted into a single response parameter associated with that set of paired color pads using the following equation:

Response parameter=(28.87423−0.245112(blueL)−0.178014(yellL)−0.382156(yellb)+0.11033(bluea)² +0.003151(yellb)² +0.003091(yellL)(blueL)−0.002856(yella)(yellb)−0.004318(yellb)(blueb))²

where:

blueL is the L* parameter of a blue color pad;

yelIL is the L* parameter of a yellow color pad;

bluea is the a* parameter of a blue color pad;

yella is the a* parameter of a yellow color pad;

blueb is the b* parameter of a blue color pad; and

yellb is the b* parameter of a yellow color pad.

Since there were eight sets of color pads, eight single response parameters were obtained.

The equation (i.e., algorithm) employed in step 420 was obtained by measuring L*a*b* color parameters on the paired color pads of multiple standard reference color charts using the Minolta Chromameter. The L*a*b* color parameters were then linearly regressed against predetermined target single response parameters for each set of paired color pads. In other words, the L*a*b* color parameters measured on paired color pads associated with selected levels of blood glucose (e.g., 25 mg/dL, 50 mg/dL, etc.) were regressed against predetermined target single response parameters (i.e., the selected levels of blood glucose). The single response parameter is, therefore, essentially a predicted blood glucose target level for the paired color pads.

Since the variance of the L*a*b* color parameters was blood glucose level dependent, a square root transformation was used to normalize variance. The nine terms of the equation were selected from all possible terms based on principal component analysis and statistical significance.

Table 1 below lists results obtained from step 420 for eight sets of paired colored pads from multiple calibrated color charts. Each set of paired color pads corresponded to the target blood glucose levels listed in the first column. Table 1 indicates that the mean of the single response parameters for the samples of paired color pads is close to their associated target levels. However, Table 1 also indicates that the single response parameter for individual paired color pads can be significantly offset from the target (see the minimum and maximum columns of Table 1).

TABLE 1
Summary of Step 420 Results as Applied to Multiple Calibrated
Color Charts

| | | Mean Single | | | |
|---|---|---|---|---|---|
| | | Response | | | |
| | | Parameter (i.e., | | | |
| Paired Color | | Predicted Mean | | | |
| Pad Target | Sample | Blood Glucose | Standard | Mini- | Maxi- |
| Glucose Level | Size | Level | Deviation | mum | mum |
| 25 mg/dL | 1867 | 25.29 | 1.69 | 20.07 | 29.62 |
| 50 mg/dL | 1809 | 50.17 | 1.76 | 45.01 | 54.74 |
| 80 mg/dL | 1744 | 80.55 | 1.75 | 75.06 | 84.97 |
| 120 mg/dL | 1693 | 120.96 | 2.37 | 114.04 | 125.89 |
| 180 mg/dL | 1775 | 181.08 | 3.26 | 171.00 | 188.81 |
| 240 mg/dL | 1841 | 239.72 | 4.17 | 228.01 | 251.62 |
| 400 mg/dL | 1827 | 400.37 | 7.66 | 381.86 | 419.94 |
| 600 mg/dL | 1873 | 598.61 | 11.90 | 570.93 | 629.69 |

Next, the single response parameters for each set of paired color pads was compared to predetermined single response parameter specifications for each set and acceptance of the sample calibrated color chart determined based on the comparison, as set forth in step 430. In this example, the predetermined single response parameter specification was the target blood glucose level for each paired set of color pads+/−5 mg/dL for targets below 100 mg/dL and the target+/−5% of the target for targets above 100 mg/dL. In the event that any single response parameter was outside of its associated predetermined single response parameter specification, the associated color chart would be rejected as unacceptable. On the other hand, if all single response parameters were within their associated predetermined single response parameter specifications, the associated color chart would be deemed acceptable.

This exemplary method for acceptance testing in accordance with the present invention provides several benefits compared to conventional methods. First, the paired color pads are tested as a paired set of colored workpieces rather than individually, thereby providing for the use an algorithm that contains interactive terms, such as (yellL)(blueL) that account for interactions between the colors. Second, objective visual testing is not required since the color parameters were obtained using an instrumental method. Third, the number of predetermined single response parameter specifications employed in the method was only equal to the number of sets of paired color pads being used (i.e., 8) which is a simplification by a factor of ⅙ compared to the color parameter specifications that would be required (i.e., 48) if individual L*a*b* color parameter specifications were employed. Fourth, once the equation (algorithm) for use in the converting step had been developed, standard reference color charts were no longer required. Fifth, the predetermined single response parameter specifications employed in the method are essentially recited in terms of blood glucose level (concentration), rather than a non-intuitive and non-directional term such as ΔE*_{ab}.

Method for Acceptance Testing of a Lot of Visual Test Strips with Dual Membranes

During the manufacturing of a lot of visual blood glucose test strips, acceptance testing is typically performed to determine the accuracy of results obtained with the visual blood glucose test strips included in the lot. Such acceptance testing should be objective, yet representative of visual testing.

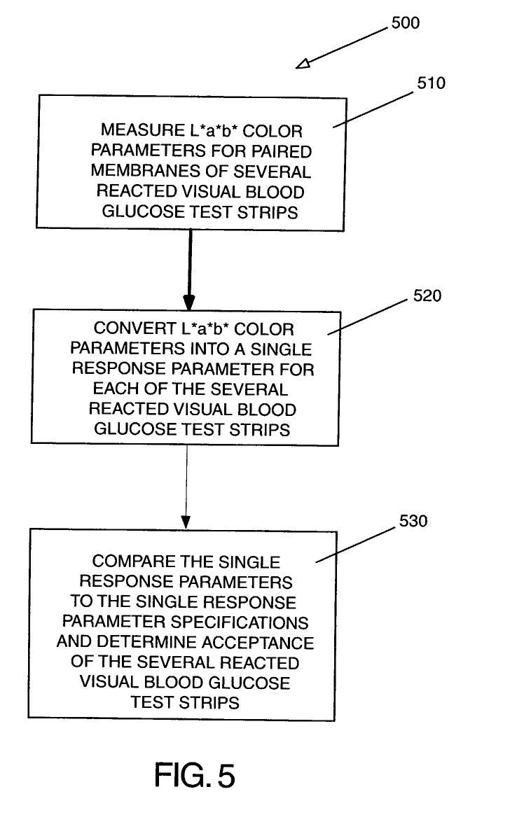

Referring to FIG. 5, a method 500 that was developed for the acceptance testing of a visual blood glucose test strip with paired membranes in accordance with the present invention is described. L*a*b* color parameters were measured for paired membranes of several visual blood glucose test strips with each of the several visual blood glucose test strips having been reacted with different blood glucose level samples, as set forth in step 510. One of the paired membranes from each visual blood glucose test strip was customarily referred to as the “blue pad” and the other as the “yellow pad.”

Next, the measured L*a*b* color parameters for the paired membranes were converted into single response parameters associated with each of the several visual blood glucose test strips using a two-step algorithm wherein an intermediate response parameter is first calculated, followed by the calculation of the single response factor, as set forth in step 520. The two-step algorithm was as follows:

First Step

Intermediate response parameter=(28.87423−0.245112(blueL)−0.178014(yellL)−0.382156(yellb)+0.11033(bluea)²+0.003151(yellb)²+0.003091(yellL)(blueL)−0.002856(yella)(yellb)−0.004318(yellb)(blueb))²

where:

blueL is the L* parameter of a blue pad;

yellL is the L* parameter of a yellow pad;

bluea is the a* parameter of a blue pad;

yella is the a* parameter of a yellow pad;

blueb is the b* parameter of a blue pad; and

yellb is the b* parameter of a yellow pad.

Second Step:

Two equations are employed in the second step, depending on concentration of blood glucose. For paired membranes reacted with blood glucose level samples of less than or equal to 150 mg/dL:

Single response parameter=−11.433457+1.053771(intermediate response parameter)

For paired membranes reacted with blood glucose level samples of greater than 150 mg/dL:

Single response parameter=−56.454328+1.433572 (intermediate response parameter)

The first step equation employed in step 520 is identical to that described with respect to method 400 and was obtained in an identical manner. Therefore, the intermediate response parameter obtained using the first step equation is essentially a blood glucose level that has been predicted based on the instrumentally measured L*a*b* color parameters of the paired membranes.

The second step equations employed in step 520 were obtained from experimentally derived correlations between a user's visual determination of blood glucose level (using standard visual blood glucose test strips and associated calibrated color charts) and a corresponding predicted blood glucose level based on L*a*b* color parameters measured on the standard visual blood glucose test strips and the first step equation. In other words, the two-step algorithm in step 520 accounts for user-related visual effects based on a correlation between a user's visually determined single response parameter and an instrument determined single response parameter. The second step equation, therefore, effectively accounts for user visual effects. The general format of such a second step equation is:

User visual response=f (Instrument-based response)

In method 500, the experimentally derived correlation led to two sets of linear equations, noted above.

Next, at step 530, the single response parameters for each set of paired membranes was compared to a predetermined single response parameter specification for each set and acceptance of the visual blood glucose test strips determined based on the comparison. Acceptance or rejection of the entire lot of visual blood glucose test strips can then be determined based on the acceptance or rejection of the several visual blood glucose test strips that underwent method 500.

Similarly with exemplary method 400, exemplary method 500 provided several benefits compared to conventional acceptance test methods for paired membranes of a visual blood glucose test strip. First, the paired membranes are tested as a paired set of colored workpieces rather than individually, thereby providing for the use an algorithm that contains interactive terms, such as (yellL)(blueL) that assess the interaction between colors of each of the paired set. Second, objective visual testing was not required since the color parameters were obtained using an instrumental method.

Third, the number of predetermined single response parameter specifications employed in the method was equal to the number of blood glucose samples reacted with paired membranes, which is a simplification by a factor of ⅙ compared to the color parameter specifications that would be required if individual L*a*b* color parameter specifications were employed. Fourth, once the equation (algorithm) for use in the converting step had been developed, standard reference color charts were no longer required.

Fifth, the predetermined single response parameter specifications employed in the method are essentially recited in terms of blood glucose level (concentration), rather than a non-intuitive and non-directional term such as ΔE*_{ab}. Sixth, the algorithm employed in the converting step included a correlation between a user's visual response determination and an instrument-based response determination, thus accounting for user-related visual effects.

It should be understood that various alternatives to the embodiments of the invention described herein may be employed in practicing the invention. It is intended that the following claims define the scope of the invention and that methods within the scope of these claims and their equivalents be covered thereby.

What is claimed is:

1. A method for the acceptance testing of a set of multiple colored workpieces, the method comprising:
measuring a plurality of color parameters associated with the set of multiple colored workpieces;
converting the plurality of color parameters into a single response parameter for the set of multiple colored workpieces; and
comparing the single response parameter for the set of multiple colored workpieces to a predetermined single response parameter specification and determining acceptance of the set of multiple colored workpieces based on the comparison.

2. The method of claim 1, wherein the converting step utilizes an algorithm in the form of
P=f(CP₁,CP₂, . . . , CP_{n·m})
where: P is the single response parameter; and
CP₁, CP₂ . . . CP_{n·m} are n·m color parameters associated with the set of multiple colored workpieces.

3. The method of claim 1, wherein the measuring step measures a plurality of color parameters associated with paired color pads of a calibrated color chart.

4. The method of claim 3, wherein the measuring step measures L*, a* and b* color parameters associated with the L*a*b* color space.

5. The method of claim 4, wherein the converting step employs an algorithm obtained by regressing L*, a* and b* color parameters measured on a plurality of paired color pads of standard reference calibrated color charts against predetermined single response parameters for each of the paired color pads in a linear combination.

6. The method of claim 5, wherein the algorithm has at least one interactive term that includes at least one L*, a* and b* color parameter from each of one paired set of color pads of the calibrated color chart.

7. The method of claim 1, wherein the measuring step measures a plurality of color parameters associated with paired membranes of a visual blood glucose test strip.

8. The method of claim 7, wherein the measuring step measures L*, a* and b* color parameters of the L*a*b* color space.

9. The method of claim 8, wherein the converting step employs an algorithm with at least one interactive term that includes at least one L*, a* and b* color parameter from each of the paired membranes of the visual blood glucose test strip.

10. The method of claim 7, wherein the converting step employs an algorithm that accounts for user-related visual effects based on a correlation between a user's visually determined single response parameter and an instrument determined single response parameter.

11. The method of claim 1, wherein the measuring step is accomplished using a chromameter.

12. The method of claim 1, wherein the measuring step is accomplished using a spectrophotometer.

13. The method of claim 1, wherein the measuring step measures X, Y and Z color parameters of the XYZ tristimulus space.

14. The method of claim 1, wherein the measuring step measures Y, x, and y values of the Y, x, y color space.

15. The method of claim 1, wherein the measuring step measures L, C and h values of the L*C*h color space.

16. The method of claim 1, wherein the measuring step measures HL, a and b values of the Hunter Lab color system.

17. A method for the acceptance testing of a color chart with a plurality of sets of paired color pads, the method comprising:
measuring L*, a* and b* color parameters of the L*a*b* color space associated with each set of the paired color pads;
converting the L*a*b* color parameters into a single response parameter for each set of the paired color pads; and
comparing the single response parameters to predetermined single response parameter specifications and determining acceptance of the color chart based on the comparison.

18. The method of claim 17, wherein the converting step utilizes an algorithm in the form of
P=f(CP₁,CP₂, . . . , CP_{n·m})
where: P is the single response parameter; and
CP₁, CP₂ . . . CP_{n·m} are n·m color parameters associated with any one set of the paired color pads.

19. The method of claim 18, wherein the algorithm has at least one interactive term that includes at least one L*, a* and b* color parameter from each color pad of one set of paired color pads.

20. The method of claim 17, wherein the measuring step is accomplished using a chromameter.

21. The method of claim 17, wherein the measuring step is accomplished by a spectrophotometer.

22. The method of claim 17, wherein the single response parameter is recited in terms of blood glucose concentration.

23. A method for the acceptance testing of a lot of visual test strips with paired membranes, the visual test strips being used for determination of analyte concentration in a biological fluid, the method comprising:
measuring L*, a* and b* color parameters of the L*a*b* color space associated with paired membranes of at least one visual test strip in the lot;
converting the L*a*b* color parameters into a single response parameter for the paired membranes of the at least one visual test strip; and
comparing the single response parameters to predetermined single response parameter specifications and determining acceptance of the lot based on the comparison.

24. The method of claim 23, wherein the converting step utilizes an algorithm in the form of
P=f(CP₁,CP₂, . . . ,CP_{n m})
where: P is the single response parameter; and
CP₁, CP₂ . . . CP_{n·}m are n·m color parameters associated with paired membranes of one visual test strip.

25. The method of claim 24, wherein the converting step employs the algorithm and the algorithm has at least one interactive term that includes at least one L*, a* and b* color parameter from each paired membrane of the one visual test strip.

26. The method of claim 24, wherein the converting step employs an algorithm and the algorithm has at least one interactive term that includes at least one L*, a* and b* color parameter from each paired membrane of the one visual test strip that has been reacted with the analyte.

27. The method of claim 24, wherein the converting step further utilizes an algorithm in the form of
User visual response=f (Instrument-based response)
that accounts for user-related visual effects.

28. The method of claim 23, wherein the measuring step is accomplished using a chromameter.

29. The method of claim 23, wherein the measuring step is accomplished using a spectrophotometer.

30. The method of claim 23 wherein the measuring step measures L*, a* and b* color parameters associated with paired membranes of at least one blood glucose visual test strip.

31. The method of claim 23, wherein the single response parameter is recited in terms of blood glucose concentration.
